(19) United States
(12) Patent Application Publication
(10) Pub. No.: US 2017/0370470 A1
(43) Pub. Date: Dec. 28, 2017

(54) FLUID CONVEYANCE SYSTEM GASKET ASSEMBLY AND METHODS OF ASSEMBLING THE SAME

(71) Applicant: Corner Star Limited, Kowloon (HK)

(72) Inventor: Lee Frederick Chusak, St. Louis, MO (US)

(21) Appl. No.: 15/540,418

(22) PCT Filed: Dec. 30, 2015
(86) PCT No.: PCT/US2015/068004

§ 371 Date: Jun. 28, 2017

Related U.S. Application Data
(60) Provisional application No. 62/098,027, filed on Dec. 30, 2014.

(51) Int. Cl. F16J 15/10; F16L 23/20; F16L 23/02

(52) U.S. Cl. CPC F16J 15/104; F16L 23/20; F16L 23/02

(57) ABSTRACT

A gasket assembly (200) for use in a fluid conveyance system (100) is provided. The gasket assembly (200) includes first ring (202) circumscribing a flow channel (104) and comprising an inner surface (216) having a notch (218) formed therein. The gasket assembly (200) also includes a dust shield (206) at least partially inserted into the notch (218). The dust shield (206) is positioned between the first ring (202) and the flow channel (104) to prevent particulates of the first ring (202) from entering the flow channel (104).

### CROSS-REFERENCE TO RELATED APPLICATION

This application claims priority to U.S. Provisional Patent Application No. 62/098,027 filed on 30 Dec. 2015, the entire disclosure of which is hereby incorporated by reference in its entirety.

### FIELD

The field of the disclosure relates generally to systems and methods for providing a seal within a fluid conveyance system and, more particularly, to systems and methods for preventing particle entry into a fluid flow channel.

### BACKGROUND

Many conventional fluid conveyance systems include channeling a fluid through two or more sections of a conduit. For example, a fluidized bed reactor (FBR) is a type of fluid conveyance system that can be used to carry out a variety of multiphase chemical reactions. In this type of reactor, a fluid (gas or liquid) is passed through a conduit and into a chamber that contains a granular solid material (usually a catalyst possibly shaped as tiny spheres) at high enough velocities to suspend the solid and cause it to behave as though it were a fluid.

Because FBRs channel the fluid at a high velocity, a robust seal is required between adjacent portions of the conduit through which the fluid is being channeled. Traditionally, standard metallic ring type joint (RTJ) gaskets are used in such high pressure service. RTJ gaskets seal by creating a metal on metal seal between the gasket and opposing flanges of the adjacent conduits. The RTJ gaskets are chosen such that the gasket material is softer than the flange face so that when it seats, the gasket is embedded in the flanges.

In many higher flange classes (class 600 and above) the bolts that connect the flanges have enough strength to properly seat the metallic RTJ gasket. However, in lower flange classes, such as classes 150 and 300, the bolts may not have enough strength to properly seat the gaskets.

Furthermore, some RTJ gaskets have the potential to shed particulates from the facing materials of the gasket when it is being seated. These particles may travel to the flow channel and become entrained in the fluid flowing therethrough and contaminate the desired reaction.

Accordingly, a need exists for a gasket that has a lower seating stress to enable the gasket to be properly seated and also that prevents entrainment of gasket particles in the fluid flow.

This Background section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### BRIEF SUMMARY

A gasket assembly for use in a fluid conveyance system is provided. The gasket assembly includes a first ring circumscribing a flow channel and comprising an inner surface having a notch formed therein. The gasket assembly also includes a dust shield at least partially inserted into the notch. The dust shield is positioned between the first ring and the flow channel to prevent particulates of the first ring from entering the flow channel.

A fluid conveyance system for channeling a fluid through a flow channel is provided. The fluid conveyance system includes a first conduit comprising a first flange, a second conduit comprising a second flange, and a gasket assembly positioned between the first and second flange to form a seal therebetween. The gasket assembly includes an outer ring comprising a radially inner surface having a notch formed therein and a dust shield at least partially inserted into the notch. The dust shield is positioned between the outer ring and the flow channel to prevent particulates of the outer ring from entering the flow channel.

A method of assembling a fluid conveyance system includes providing a first ring having a notch formed therein, wherein the first ring circumscribes a flow channel. A second ring is then at least partially inserted into the notch. The method also includes attaching a third ring to the second ring such that the second ring spaces the first ring from the third ring. The third ring is positioned between the first ring and the flow channel to prevent particulates of the first ring from entering the flow channel.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated embodiments may be incorporated into any of the above-described aspects, alone or in any combination.

### BRIEF DESCRIPTION OF THE DRAWINGS

FIG. 1 is cross-section of a fluid conveyance system including an embodiment of a gasket assembly;

FIG. 2 is a top plan view of the gasket assembly of FIG. 1;

FIG. 3 is a cross-section of an outer ring of the gasket assembly taken along line 3-3 in FIG. 2;

FIG. 4 is a top plan view of an intermediate ring of the gasket assembly of FIG. 2;

FIG. 5 is a top plan view of an inner ring of the gasket assembly of FIG. 2; and

FIG. 6 is a cross-section of a portion of the fluid conveyance system taken along line 6-6 in FIG. 2.

Corresponding reference characters indicate corresponding parts throughout the several views of the drawings.

### DETAILED DESCRIPTION

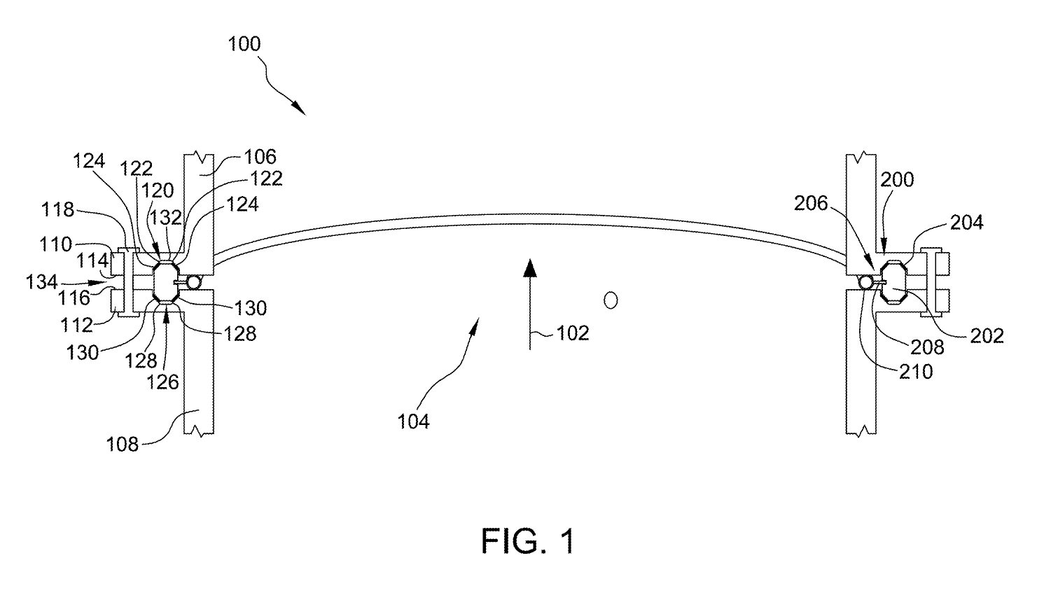

Referring to FIG. 1, a fluid conveyance system is shown and is indicated generally at 100. The fluid conveyance system 100 is used to channel a flow of fluid 102 through a flow channel 104 to desired destination. In one embodiment, the fluid conveyance system 100 is a portion of a fluidized bed reactor. More specifically, fluid conveyance system 100 is used in a high purity gas service on a gas inlet of the fluidized bed reactor. In another suitable embodiment, the fluid conveyance system 100 is a portion of any system that facilitates operation of the fluid conveyance system 100 as described herein.

The illustrated fluid conveyance system 100 includes a first conduit 106 connected to a second conduit 108. More specifically, the first conduit 106 includes a first flange 110 that is connected to a second flange 112 of the second conduit 108. When the fluid conveyance system is assembled, the first and second conduits 106 and 108 define the flow channel 104 therethrough. Furthermore, the first flange 110 includes a first surface 114 that is oriented opposite a second surface 116 of the second flange 112. The flanges 110 and 112 are connected to each other using a fastener 118 inserted through openings defined in each of the flanges 110 and 112.

The first flange 110 also includes a first groove 120 defined therein. The first groove 120 includes a pair of obliquely-oriented walls 122, each of which includes an engaging surface 124. Each engaging surface 124 includes a plurality of grooves, ridges, or teeth, as described in further detail below. Similarly, the second flange 112 includes a second groove 126 defined therein. The second groove 126 includes a pair of obliquely-oriented walls 128, each of which include an engaging surface 130 that includes a plurality of grooves, ridges, or teeth, as described in further detail below. The first and second grooves 120 and 126 are aligned such that the grooves 120 and 126 define a cavity 132 therebetween.

The fluid conveyance system 100 also includes a gasket assembly 200 positioned within the cavity 132 such that the first and second surfaces 114 and 116 are spaced apart by a gap 134. The gasket assembly 200 includes an outer ring 202, a plurality of sealing strips 204, and a dust shield 206. Both the plurality of sealing strips 204 and the dust shield are attached to the outer ring 202. More specifically, the dust shield 206 includes an intermediate ring 208 attached to the outer ring 202 and an inner ring 210 attached to the intermediate ring 208.

The gasket assembly 200 is configured to provide a seal between the flanges 110 and 112 of the conduits 106 and 108 to prevent the fluid 102 within the flow channel 104 from escaping between flanges 110 and 112. More specifically, the outer ring 202 provides the fluid sealing between flanges 110 and 112 and the dust shield 206 provides for a particle seal between the outer ring 202 and the flow channel 104. More specifically, the dust shield 206, and therefore the intermediate ring 208 and the inner ring 210, are positioned within the gap 134 between the flanges 110 and 112 to prevent any particles from the outer ring 202 and/or the sealing strips 204 from entering the flow channel 104 and contaminating the fluid 102 flowing therethrough.

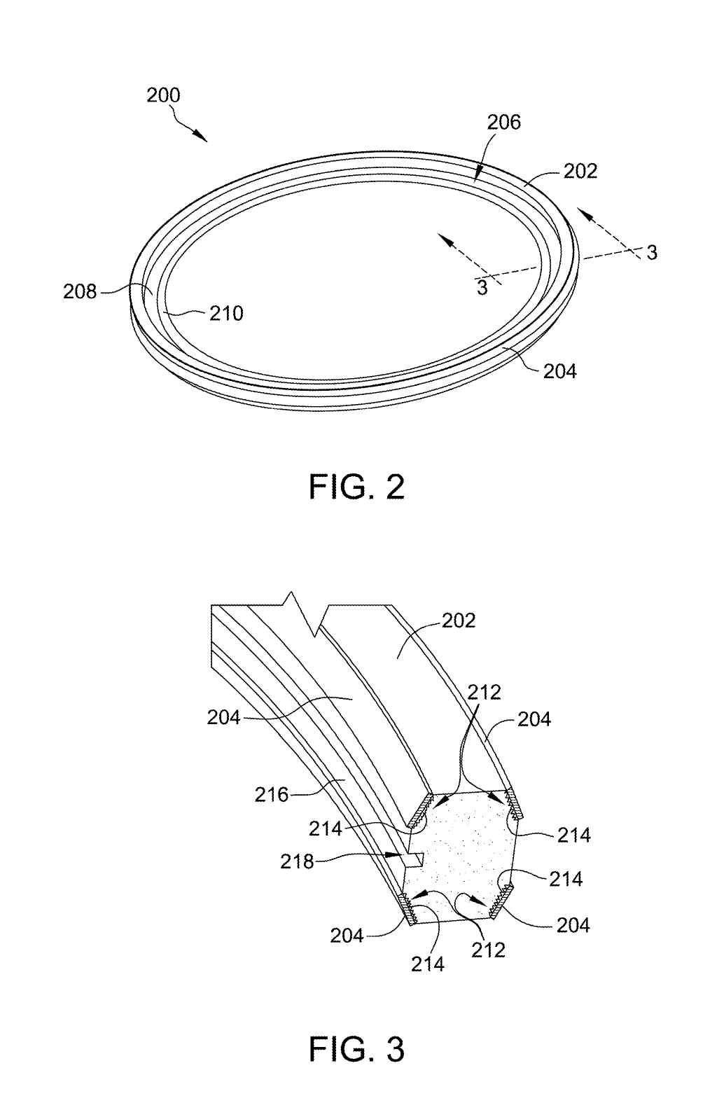

FIG. 2 shows a top plan view of the gasket assembly 200 including the outer ring 202 and the dust shield 206. As described above, the dust shield 206 includes the intermediate ring 208 and the inner ring 210.

FIG. 3 is a cross-section of the outer ring 202 of the gasket assembly 200 taken along line 3-3 in FIG. 2. In one embodiment, the outer ring 202 is an octagonal Kammprofile ring joint gasket. In other suitable embodiments, the outer ring 202 is any type of ringed gasket seal that facilitates operation of the fluid conveyance system as described herein. The outer ring 202 includes a plurality of obliquely-oriented engaging surfaces 212 that each includes a plurality of grooves or ridges 214 formed thereon. The sealing strips 204 are attached to the outer ring 202 at a respective engaging surface 212 such that each sealing strip 204 is positioned on the plurality of grooves 214 of a respective engaging surface 214.

In one embodiment, the outer ring 202 is formed from a metallic material, such as, but not limited to, stainless steel, nickel-chromium alloy, and chromium-steel alloy. More specifically, the outer ring 202 is formed from a metallic material such that the outer ring 202 includes a seating stress within a range of between approximately 2,500 pounds per square inch (psi) and approximately 5,000 psi. In another suitable embodiment, the outer ring 202 may have any seating stress that enables operation of the fluid conveyance system as described herein. Furthermore, the plurality of sealing strips 204 are formed from a metallic material that is softer than the materials of the outer ring 202 and the flanges 110 and 112. More specifically, the plurality of sealing strips 204 are formed from a material such as, but not limited to, graphite, exfoliated vermiculite, mica, or polytetrafluoroethylene.

The outer ring 202 also includes an inner surface 216 that includes a notch 218 defined therein. As described in further detail below, the notch 218 is configured to receive at least a portion of the dust shield 206 therein.

FIG. 4 is a top plan view of the intermediate ring 208 of the gasket assembly 200. The intermediate ring 208 includes an inner edge 220, an outer edge 222, and a width W1 defined therebetween. In one embodiment, the intermediate ring 208 is C-shaped and includes a first end 224, a second end 226, and a gap 228 defined therebetween. The C-shape of intermediate ring 208 facilitates moving the ends 224 and 226 independently of each other to increase the ease of assembly of the gasket assembly 200. In another suitable embodiment, the intermediate ring 208 is a continuous ring and does not include the gap 228. As described herein, the outer edge 222 of the intermediate ring 208 is inserted into the notch 218 defined in the outer ring 202 to attach the dust shield 206 to the outer ring 202.

In one embodiment, the intermediate ring 208, and therefore, the dust shield 206, is free to float within the notch 218 and is not positively attached to the outer ring 202 by any mechanical or bonding means. In another suitable embodiment, the intermediate ring 208 is positively attached to the outer ring 202 within the notch 218. In one embodiment, the intermediate ring 208 is a substantially flat ring formed from a metallic material, such as, but not limited to stainless steel. In another suitable embodiment, the intermediate ring 208 is formed from any material that facilitates operation of the fluid conveyance system as described herein.

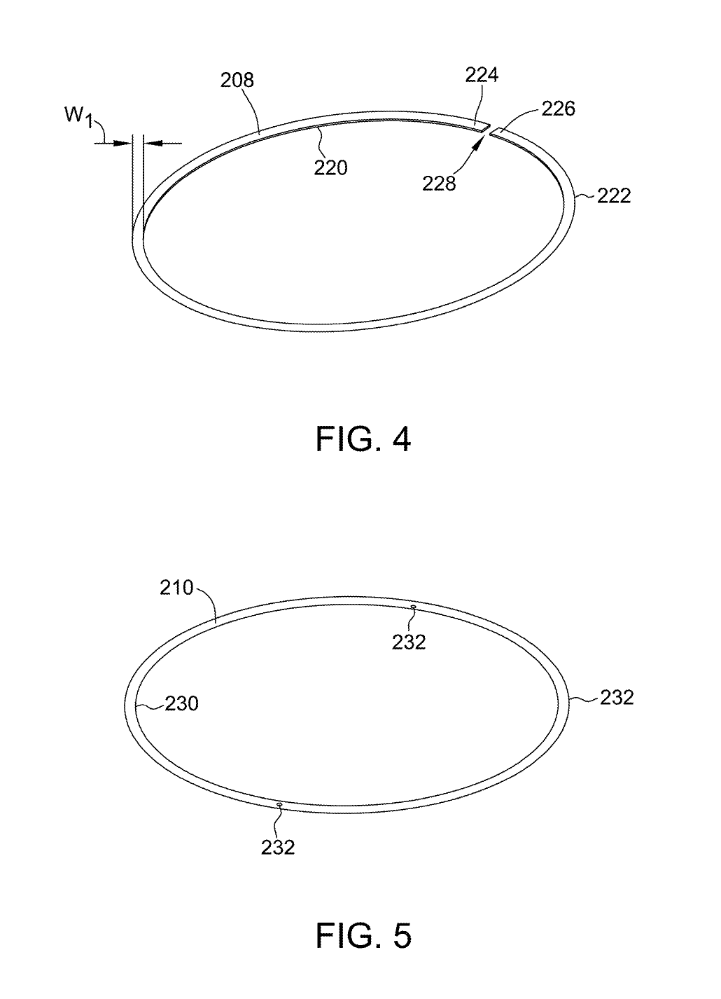

FIG. 5 is a top plan view of the inner ring 210 of the gasket assembly 200. The inner ring 210 is a substantially hollow crushable tube ring that includes a radially inner surface 230 and a radially outer surface 232. In one embodiment, the radially outer surface 232 is attached to the radially inner edge 220 of the intermediate ring 208 by tack welding. In another suitable embodiment, the inner ring 210 is attached to the intermediate ring 208 by any means that enables operation of the fluid conveyance system described herein.

The inner ring 210 also includes a pair of vent holes 234 formed therein. More specifically, the vent holes 234 are formed at opposite points of the inner ring with respect to one another. That is, the vent holes 234 are formed 180 degrees apart from one another. The vent holes 234 are configured to prevent a pressure differential from developing across the inner ring 210 when it is installed between the flanges 110 and 112. More specifically, the vent holes 232 prevent a pressure differential between the flow channel side of the inner ring 210 and the space defined between the inner ring 210 and the outer ring 202. Moreover, the vent holes 232 are formed 180 degrees apart to maximize the distance that a particle, from the outer ring 202 and/or the sealing strips 204, within the inner ring 210 would have to travel in order to escape the inner ring 210 and mix with the fluid 102 within the flow channel 104 (this may be termed a “tortuous path”).

In one embodiment, the inner ring 210 is formed from a metallic material, such as but not limited to stainless steel. In another suitable embodiment, the inner ring 210 is formed from any material that facilitates operation of the fluid conveyance system 100 as described herein. More specifically, the inner ring 210 is formed from any material that deforms when the first and second flanges 110 and 112 are tightened together.

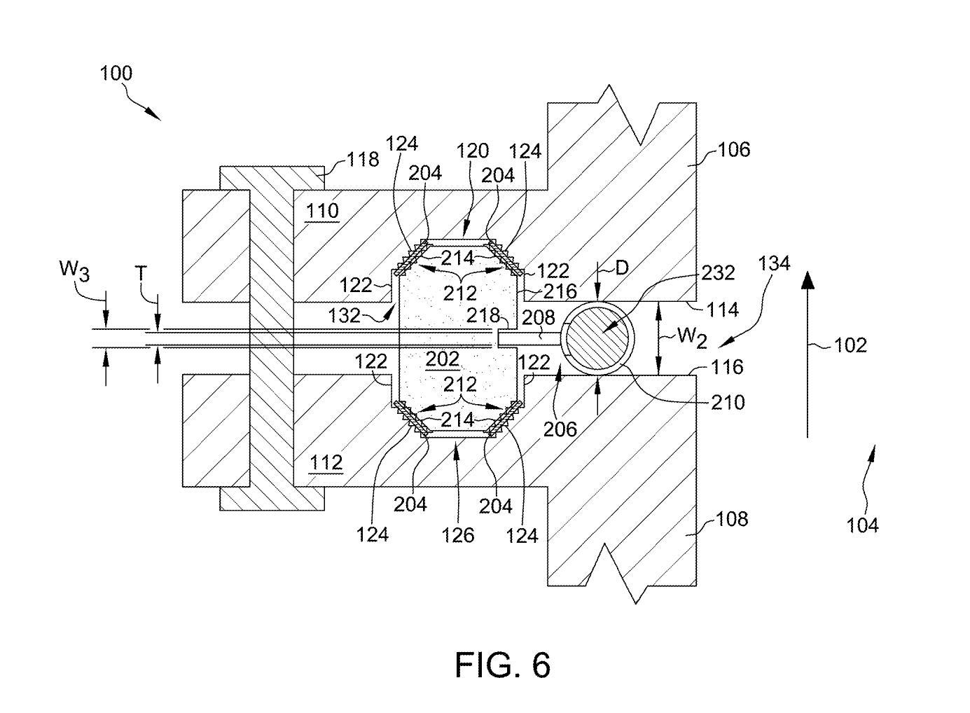

FIG. 6 is a cross-section of a portion of the fluid conveyance system 100 taken along line 6-6 in FIG. 2. As shown in FIG. 6, the inner ring 210 includes a diameter D that is substantially similar to a width W2 of the gap 134 between flange surfaces 114 and 116. In another suitable embodiment, the inner ring 210 includes a diameter that is slightly less than or slightly greater than the width of the gap 134. As such, the inner ring 210 spans the gap 134 and extends the full distance between the flange surfaces 114 and 116 when the fluid conveyance system is assembled.

In operation, the outer ring 202 is positioned within the second groove 126 such that the sealing strips 204 are positioned between the ridges 214 of the outer ring 202 and the engaging surface 124 of the second groove 126. The dust shield 206 is assembled by attaching the inner edge 220 of the intermediate ring 208 to the outer surface 232 of the inner ring 210. The dust shield is then seated within the notch 218 defined in the inner surface 216 of the outer ring 202. The intermediate ring 208 includes a thickness T that is slightly less than a width W3 of the notch 218 such that the outer edge 222 of the intermediate ring is partially inserted into the notch 218. As described above, in one embodiment, the dust shield 206 is not positively fastened to the outer ring 202 by any means.

Once the dust shield 206 is in place, the first conduit 106 is positioned such that the first groove 120 receives a portion of the outer ring 202. More specifically, similar to the second groove 126, the outer ring 202 is positioned within the first groove 120 such that the sealing strips 204 are positioned between the ridges 214 of the outer ring 202 and the engaging surface 124 of the first groove 120.

In such a configuration, as shown in FIG. 6, the dust shield 206 is positioned in the gap 134 between the opposing flange surfaces 114 and 116 such that the inner ring 210 spans the width W2 of the gap 134.

The fastener 118 is then threaded through the flanges 110 and 112 and tightened. Tightening of the fastener 118 causes the ridges of the flange engaging surfaces 124 (in the grooves 120 and 126) to engage the sealing strips 204. More specifically, the sealing strips 204 are compressed between the engaging surfaces 124 and the ridges 214 of the outer ring engaging surfaces 212. Compression of the sealing strips 204 creates the seal that prevents the fluid 102 from escaping the flow channel 104 and being exposed to the outside environment.

During tightening, it is possible that particles from the sealing strips 204 or the flanges 110 and 112 may be fragmented when the sealing strips 204 are crushed and be introduced to the gap 134. The dust shield 206 is configured to prevent those particles from traveling to the flow channel 104 and becoming entrained with the fluid 102 therein.

As the conduits 106 and 108 are connected and tightened together, the width W2 of the gap 134 between flange surfaces 114 and 116 to decrease, which, in turn, causes a compression deformation of the inner ring 210. Therefore, the inner ring 210 creates a seal between flange surfaces 114 and 116 and seals the gap 134. In such a configuration, the flow channel side of the inner ring 210 is sealed from the gasket side to prevent any particulates from the outer ring 202, the sealing strips 204, or the flanges 110 and 112 that are created during tightening from entering the flow channel 104.

As described above, the vent holes 232 are formed in the inner ring 210 to prevent a pressure differential between the flow channel side and the gasket side of the inner ring 210. The vent holes 232 equalize the pressure across the inner ring 210. Further, the vent holes 232 are drilled 180 degrees apart from one another such that if any particles enter the inner ring 210 through one vent hole 232, then the particle must travel a maximum distance around the circumference of the inner ring 210 to the other vent hole 232 to escape the inner ring 210.

The fluid conveyance system and gasket assembly of the present disclosure provide an improvement over known fluid conveyance systems and gasket assemblies. The gasket assembly of the present disclosure has a lower seating stress than known gasket assemblies, and also maintains purity levels of a fluid flow by sealing the main gasket body from the flow channel.

More specifically, the gasket assembly described herein includes a dust shield that prevents particles fragmented from other components of the fluid conveyance system from being entrained with the fluid flowing within the flow channel. The dust shield includes a centering intermediate ring and a crushable tubing inner ring. The intermediate ring is inserted into a notch formed in the outer ring and spaces the inner ring from the outer ring. The inner ring is positioned between opposing surfaces of adjacent conduits such that when the conduits are fastened together, the inner ring is deformed and forms a seal between the outer ring and the flow channel.

When introducing elements of the present invention or the embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions and methods without departing from the scope of the invention, it is intended that all matter contained in the above description and shown in the accompanying drawings shall be interpreted as illustrative and not in a limiting sense.

What is claimed is:

1. A gasket assembly for use in a fluid conveyance system, the gasket assembly comprising:
a first ring comprising an inner surface having a notch formed therein, wherein the first ring circumscribes a flow channel; and
a dust shield at least partially inserted into the notch, the dust shield positioned between the first ring and the flow channel to prevent particulates of the first ring from entering the flow channel.

2. The gasket assembly of claim 1, wherein the dust shield comprises a second ring partially inserted into the notch and a third ring attached to the second ring.

3. The gasket assembly of claim 2, wherein the second ring is substantially C-shaped and includes a first end, a second end, and a gap defined therebetween.

4. The gasket assembly of claim 2, wherein the second ring is substantially flat and includes a thickness less than a width of the notch.

5. The gasket assembly of claim 2, wherein the third ring is substantially tubular.

6. The gasket assembly of claim 2, wherein the third ring comprises at least one vent hole formed therein to prevent a pressure differential across the third ring.

7. The gasket assembly of claim 2, wherein the third ring is configured to deform to form a seal between the first ring and the flow channel.

8. The gasket assembly of claim 1, wherein the dust shield is formed from a metallic material.

9. A fluid conveyance system for channeling a fluid through a flow channel, the fluid conveyance system comprising:
a first conduit comprising a first flange;
a second conduit comprising a second flange;
a gasket assembly positioned between the first and second flange to form a seal therebetween, the gasket assembly comprising:
an outer ring comprising a radially inner surface having a notch formed therein; and
a dust shield at least partially inserted into the notch, the dust shield positioned between the outer ring and the flow channel to prevent particulates of the outer ring from entering the flow channel.

10. The fluid conveyance system of claim 9, wherein the first flange comprises a first groove formed therein and the second flange comprises a second groove formed therein such that the first and second grooves combine to form a cavity, and wherein the outer ring is positioned within the cavity.

11. The fluid conveyance system of claim 9, wherein the outer ring comprises a plurality of first engaging surfaces, the first groove comprises at least one second engaging surface, and the second groove comprises at least one third engaging surface, and wherein the gasket assembly includes a plurality of sealing strips positioned between a first engaging surface of the plurality of first engaging surfaces and the second engaging surface and between a second engaging surface of the plurality of first engaging surfaces and the third engaging surface.

12. The fluid conveyance system of claim 11, wherein each of the first, second, and third engaging surfaces comprise a plurality of ridges configured to contact a respective sealing strip.

13. The fluid conveyance system of claim 9, wherein the first flange comprises a first surface and the second flange comprises a second surface spaced from the first surface to define a gap therebetween, and wherein the dust shield is positioned within the gap and is configured to deform to form a seal between the outer ring and the flow channel.

14. The fluid conveyance system of claim 9, wherein the dust shield comprises an intermediate ring partially inserted into the notch and an inner ring attached to the intermediate ring.

15. The fluid conveyance system of claim 14, wherein the inner ring is substantially tubular.

16. The fluid conveyance system of claim 14, wherein the inner ring comprises at least one vent hole formed therein to prevent a pressure differential across the third ring.

17. The fluid conveyance system of claim 16, wherein the at least one vent hole comprises a pair of vent holes formed in the inner ring, and wherein the pair of vent holes are formed approximately 180 degrees apart from one another.

18. The fluid conveyance system of claim 14, wherein the inner ring is configured to deform to form a seal between the outer ring and the flow channel.

19. A method of assembling a fluid conveyance system comprises:
providing a first ring having a notch formed therein wherein the first ring circumscribes a flow channel;
at least partially inserting a second ring into the notch;
attaching a third ring to the second ring such that the second ring spaces the first ring from the third ring, wherein the third ring is positioned between the first ring and the flow channel to prevent particulates of the first ring from entering the flow channel.

20. The method of claim 19 further comprising inserting the first ring into a cavity defined by a pair of grooves formed in adjacent portions of a fluid flow conduit.
